(19) United States
(12) Patent Application Publication
(10) Pub. No.: US 2026/0299910 A1
(43) Pub. Date: Oct. 1, 2026

(54) CODE MODERNIZATION

(71) Applicant: Mechanical Orchard, Inc., San Francisco, CA (US)

(72) Inventors: Robert Charles MEE, San Francisco, CA (US); Roberto OSTINELLI, Milan (IT); Michael John MCCORMACK, Washington, DC (US)

(21) Appl. No.: 19/629,966

(22) Filed: Mar. 26, 2026

Related U.S. Application Data
(60) Provisional application No. 63/778,002, filed on Mar. 26, 2025.

(51) Int. Cl. G06F 11/3604; G06F 8/35; G06F 11/3668

(52) U.S. Cl. CPC G06F 11/3608; G06F 8/35; G06F 11/3684; G06F 11/3688

(57) ABSTRACT

Methods, systems, and apparatus, including computer programs encoded on computer storage media, for automatically modernizing legacy code bases using backtesting. One of the methods includes parsing a legacy code base to identify data flows between modules executing on a legacy production system. Production data inputs and expected legacy outputs are captured to generate backtest packets. A large language model (LLM) agent generates a modern code candidate. The modern code candidate is executed using the production data inputs to generate modern outputs, which are compared to the expected legacy outputs to determine behavioral equivalence. If behavioral equivalence has not been achieved, discrepancies are computed and added to an updated system context, and the LLM agent uses the updated system context to iteratively generate an updated modern code candidate.

### CROSS-REFERENCE TO RELATED APPLICATIONS

This application claims the benefit under 35 U.S.C. § 119(e) of the filing date of U.S. Provisional Patent Application No. 63/778,002, filed on Mar. 26, 2025, entitled “Data-Validation Driven System for Replicating Legacy Code Behavior in Modern Code via Generative AL,” the entirety of which is herein incorporated by reference.

### BACKGROUND

This specification relates to modernizing legacy code bases.

Software systems are invariably initially developed in order to act as engines of efficiency and productivity, serving as strategic assets for the organizations that rely on them. Over time, however, these aging legacy software systems increasingly become strategic liabilities.

This degradation can manifest in several ways. For example, system documentation often does not exist or goes out of date, and crucial context regarding the system's architecture and functionality is lost as the original developers retire. Consequently, maintaining the existing baseline can become a majority of an information technology (IT) team's work.

Moreover, modifying the system becomes exceptionally challenging due to antiquated technologies, a lack of sufficient testing frameworks, and an inability to recover quickly from system failures.

Legacy software modernization has traditionally required immense amounts of manual effort focused primarily on code conversion. Prevailing approaches to modernization attempt to replicate behavior and convert legacy system code into a modern form, often utilizing a waterfall model. However, the sheer complexity of legacy systems, combined with the obscurity of the languages and architectures found within them, severely complicates these code conversion efforts. The combinatorial complexity of the range of possible inputs, archaic programming patterns that leverage interconnected global variables, and system architectures that have ballooned over decades conspire to make prevailing conversion approaches difficult to reason about, ineffective, and costly.

In addition, traditional modernization efforts continually fail due to their inability to adapt to changing priorities, instead demanding all-or-nothing outcomes that attempt to migrate massive systems all at once.

During these traditional migrations, attempts to manually fix unreadable or obscure legacy code frequently introduce new issues into the system. This causes risk to accumulate over years of development, leaving completion dates and code quality highly uncertain, and often resulting in projects that fail to successfully reach production.

Ultimately, with these prevailing code-focused methods, it is exceedingly difficult to have confidence that a modernized implementation correctly reproduces the true behavior of the legacy system across all expected inputs.

### SUMMARY

This specification describes how a modernization computing system can translate legacy software systems into modern application architectures by utilizing captured production data to guide and validate modern code output using generative artificial intelligence (AI) subsystems. This allows the system to shift the focus of modernization from traditional line-by-line code conversion to behavioral replication, using deterministic data flows to ensure that the same inputs to both the legacy and modern systems produce equivalent outputs. The system can parse legacy source code to extract dependencies, securely capture historical production data runs as backtest packets, and orchestrate one or more large language models to generate candidate modern code.

Moreover, the iterative backtesting loops described in this specification enable the system to automatically identify execution discrepancies against the captured data and direct the AI subsystems to heal the modern code until it replicates the legacy system's behavior. Ultimately, this combination of deterministic data capture and non-deterministic AI code generation ensures that the resulting modernized code is correct, maintainable, and able to be deployed to production immediately.

Particular embodiments of the subject matter described in this specification can be implemented so as to realize one or more of the following advantages. Providing the functionality to validate non-deterministic AI-generated code against deterministically captured backtest packets allows the computing system to shift the modernization focus from traditional line-by-line code translation to true behavioral replication. This functionality uniquely ensures that the modernized implementation correctly reproduces the behavior of the legacy system across a set of inputs. These steps substantially mitigate the hallucinogenic tendencies of some large language models by structuring their outputs within a deterministic framework.

Furthermore, the iterative backtesting loops and automated healing mechanisms described in this specification enable organizations to avoid the high failure rates, accumulated risks, and uncertain completion dates associated with traditional all-or-nothing migration efforts. Using incremental, data-driven modernization allows the system to achieve behavioral, performance, and integration equivalence, ensuring that modernized workloads can seamlessly communicate with unmigrated legacy components. This mechanism accelerates confident code conversion and enables the resulting modernized code to be robust, well-factored, and deployed to production environments. In addition, improvements and future innovations to the modernized codebase can be continuously regression-tested against the historical suite of production data packets, preventing regressions and maintaining stability between what the system does and how it is implemented.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flowchart that illustrates an overall example of a behavior replication process.

FIG. 2 is a diagram that illustrates an example system.

FIG. 3 is a flowchart of an example process for generating and iteratively validating modern replica candidates.

Like reference numbers and designations in the various drawings indicate like elements.

### DETAILED DESCRIPTION

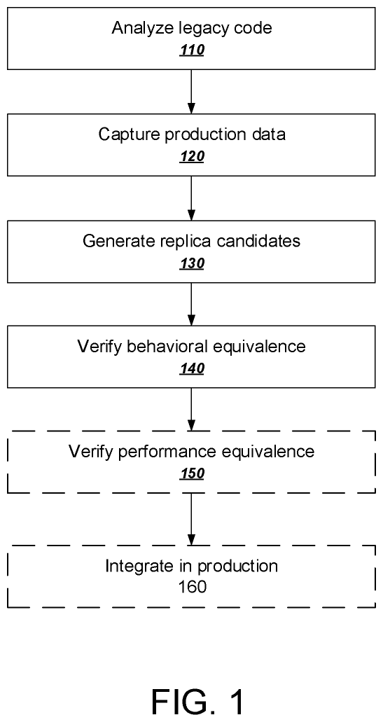

FIG. 1 is a flowchart that illustrates an overall example of a behavior replication process. The example process can be performed by a system of one or more computers in one or more locations and programmed in accordance with this specification. The example process will be described as being performed by a system of one or more computers.

The system analyzes legacy source code (110). To effectively select and prioritize jobs for migration, the system utilizes deterministic parsing to comprehend data relationships, data flows, and dependencies within the legacy codebase. The system can use this analysis to identify workload entry points and to design a robust data capture strategy for subsequent steps.

The system captures production data (120). Based on the data flows identified during the analysis step, the system instruments the legacy environment to securely fetch inputs before a job begins and outputs after a job ends. This process creates a suite of historical data, which in this specification will be referred to as backtest packets, that capture the actual production behavior of the legacy system across various timeframes and data scenarios.

The system generates modern replica candidates (130). The system can orchestrate one or more large language model (LLM) agents to use input legacy code and system-generated context to translate the legacy code into a modern implementation.

In this specification, a large language model (LLM) is an artificial intelligence system configured to autoregressively generate a next token in a sequence using integrated self-attention mechanisms. Such models typically include one or more transformer layers and can include an encoder, a decoder, or both. Furthermore, in this specification, an LLM agent is a software program or module configured to make use of an LLM to perform a particular task or sequence of tasks within an operating environment. For example, the modernization system can utilize one or more LLM agents equipped with specific skills to automatically read legacy source code, interact with legacy interfaces, and generate modernized code candidates.

The system can be configured to translate into any appropriate modern language, e.g., Elixir, Python, or Java, to name just a few examples. The generation process can be facilitated by AI-assisted characterization testing, wherein the system runs suites of tests against the legacy implementation and the replica candidates. The system can utilize synthetic data to ensure the newly generated modern code accurately mimics individual job steps.

The system verifies behavioral equivalence (140). To gain confidence for production readiness in all data scenarios, the system can execute the generated modern replica candidate against the historical suite of captured production data packets. The system can then compare the outputs generated by the modern code with the outputs captured from the legacy system to ensure they are equivalent. If discrepancies exist, the system computes the differences and iteratively heals the generated code until behavioral equivalence is achieved.

The system optionally verifies performance equivalence (150). In addition to confirming that the modern code produces equivalent output for the same inputs, the system tests the modern code to ensure it produces the equivalent output in the same amount of time or less than the legacy system. This verification provides the necessary confidence for a production cutover.

The system optionally integrates the modernized code into production (160). Once behavioral and performance equivalence are validated, the system can deploy each verified modernized workload into a modern runtime environment where it can operate compatibly with unmigrated legacy components. By achieving integration equivalence, the modernized workload can seamlessly communicate with upstream and downstream legacy consumers, unlocking incremental modernization opportunities without the risks associated with a traditional migration.

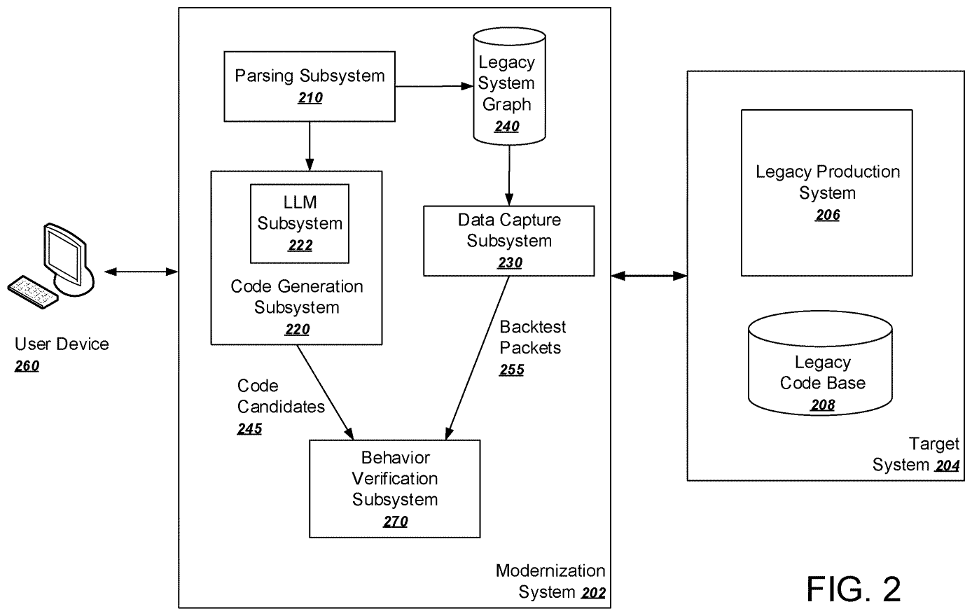

FIG. 2 is a diagram that illustrates an example system 200. The system 200 is an example of a system that can implement the legacy software modernization techniques described in this specification.

The system 200 includes a user device 260 and a modernization system 202, which is operable to translate a legacy code base 208 of a legacy production system 206 into modernized output code that can be executed by a target system 204. This functionality allows the modernization system 202 to serve as a centralized platform for the continuous assessment, translation, and verification of legacy software into modern application architectures.

There are many types of legacy production systems 206 that can be modernized by the techniques described in this specification. Typically, the legacy production system 206 is an aging hardware and operating system environment configured to execute legacy software workloads, such as batch jobs, transactional workloads, or green screen applications. By way of example, the legacy production system 206 can include mainframe computing hardware and operating systems, such as an IBM z/OS mainframe or an HPE NonStop system. Additionally or alternatively, the legacy production system 206 can include transactional mainframe environments configured to execute complex business logic and legacy user interactions. For example, the legacy production system 206 can be a system executing Customer Information Control System (CICS) screens and transactions. In further examples, the legacy production system 206 can encompass other specialized legacy mainframe environments targeted for modernization, including, but not limited to, those running Information Management System Data Communications (IMS DC) or Integrated Database Management System Application Development Systems (IDMS ADS).

Regardless of the specific hardware or operating environment, the modernization system 202 can be configured to interface with the legacy production system 206 to capture deterministic data flows and backtest packets subsequent translation into a modern target architecture.

The modernization system 202 includes a number of functional subsystems, including a parsing subsystem 210, a code generation subsystem 220, an LLM subsystem 222, a data capture subsystem 230, and a behavior verification subsystem 270. Each of these components can be implemented as computer programs installed on one or more computers in one or more locations that are coupled to each other through any appropriate communications network, e.g., an intranet or the Internet, or combination of networks.

The user device 260 can be any appropriate computing device for interfacing with and providing commands to the modernization system 202, e.g., a smart phone, a tablet computer, a laptop computer, or a desktop computer, to name just a few examples. The user device 260 can provide a user interface, such as a graphical user interface or a command-line interface, that allows a modernization engineer to trigger parsing operations, view dependencies, and track modernization progress.

In some implementations, the user interface provided by the user device 260 includes a web-based graphical user interface configured to manage, orchestrate, and track the modernization processes at scale. For example, rather than executing the iterative code generation and validation loops on a single program, the user interface allows a modernization engineer to automatically initiate these agent-driven loops across a large batch of workloads, e.g., hundreds or thousands of legacy programs simultaneously.

The user interface can then aggregate the execution results to provide a visual pipeline indicating the modernization progress of each workload at various stages, such as identifying which programs have successfully achieved 100% equivalence and pinpointing the exact failure states for those that did not.

Furthermore, the user interface provides for verification at scale by allowing the modernization system 202 to automatically execute the modern code candidates against hundreds of captured backtest packets in parallel, and subsequently presents the aggregated verification results and test coverage metrics to the user.

The parsing subsystem 210 is configured to receive and deterministically analyze the legacy code base 208 from the legacy production system 206. Based on this analysis, the parsing subsystem 210 can generate a legacy system graph 240. The legacy system graph 240 is a structured data representation that maps the dependencies, relationships, complexities, and data flows of the legacy code base 208. In some implementations, the user device 260 can present a visual representation of the legacy system graph 240 to help users rapidly identify how to sequence and prioritize modernization workloads.

In some implementations, the legacy system graph 240 is a structured data representation, such as a node-link knowledge graph, that maps the interconnected web of jobs, programs, datasets, and runtime dependencies across the legacy production system 206. The legacy system graph 240 can for example be populated with JSON-formatted output generated by the parsing subsystem 210, which systematically extracts data flows, clustering information, and complexity analysis from the legacy code base 208.

By way of an example, the legacy system graph 240 can include a first node representing a legacy batch job entrypoint, such as a Job Control Language (JCL) script. The first node can be connected via directional edges to one or more child nodes representing specific legacy dependencies, such as custom COBOL programs or built-in mainframe utilities, e.g., SORT or IDCAMS. Furthermore, these program nodes can be linked to data nodes representing the captured data flows, with edges indicating the directionality of the data (e.g., a “read” or “write” operation) and the type of data storage, such as a sequential dataset, a flat file, or a specific relational database table, e.g., a DB2 table.

As another example, the nodes and edges within the legacy system graph 240 can be annotated with detailed system metadata and configurations extracted during the deterministic parsing phase. This metadata can include complexity metrics, e.g., cyclomatic complexity scores, total lines of code, and specific runtime configurations or parameters passed between legacy programs, to name just a few examples. Additionally, the edges representing data flows can be configured to track the exact source code file and line number where a given data read or write operation occurs. This granular mapping can provide the modernization system 202 with the capability to accurately trace data lineage paths, represent the internal execution logic of individual job steps, and allow a modernization engineer to assess the ripple effects of potential code changes.

The data capture subsystem 230 can utilize the data flows identified by the parsing subsystem 210 to instrument the legacy production system 206. The data capture subsystem 230 securely captures historical production data runs, including data inputs before a job begins and expected data outputs after a job ends, and stores them as backtest packets 255.

In some implementations, the data capture subsystem 230 comprises a plurality of specialized modules to interface with the legacy production system 206, e.g., a snapshotting module, a data transfer module, or an export module. The data capture subsystem 230 is configured to determine dynamic data flows through legacy job execution logs and to securely retrieve input and output datasets.

Specifically, the data capture subsystem 230 can identify the correct temporal execution windows to safely fetch inputs immediately before a particular legacy job begins and to fetch the resulting outputs immediately after the job completes. This extraction process can be automated at scale across various workloads and timeframes to build a robust suite of repeatable test cases.

Furthermore, the data capture subsystem 230 can be configured to support a variety of legacy data storage formats, including sequential datasets, flat files, and massive relational or hierarchical databases. For database capture, the data capture subsystem 230 can utilize change data capture (CDC) streams and point-in-time snapshotting techniques to efficiently record the state of large database tables without requiring the system to halt production operations. The captured historical data, along with its associated execution metadata can be consolidated, cataloged, and securely saved in cloud storage as the backtest packets 255.

By utilizing actual production data rather than relying solely on synthetic data, these backtest packets 255 help to accurately encapsulate real-world production scenarios and unpredictable edge cases, thereby giving the system the ability to perform rigorous and data-driven verification of the modern code candidates 245.

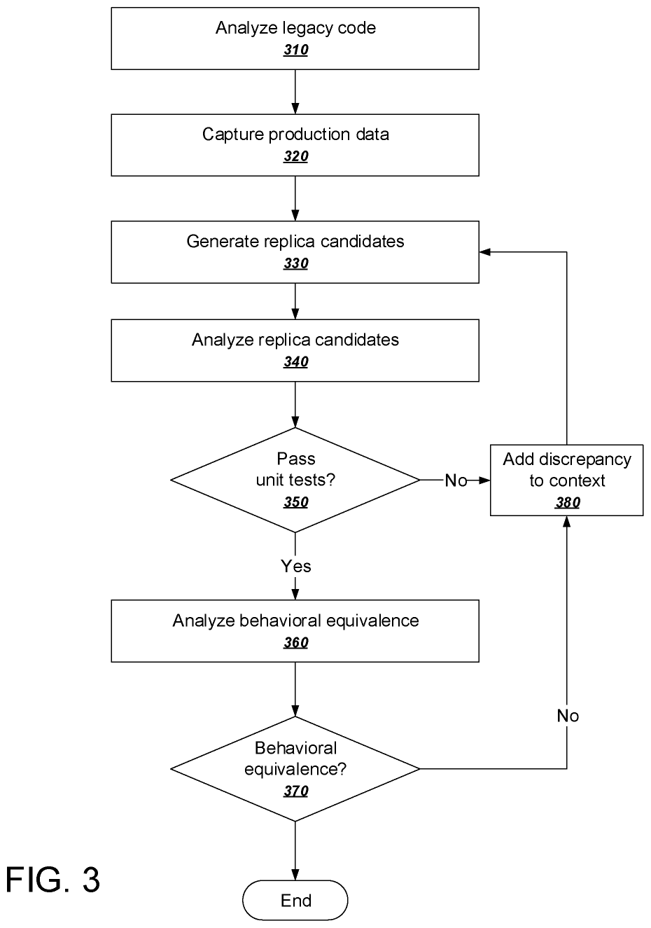

The code generation subsystem 220 works in conjunction with the LLM subsystem 222 to translate the legacy logic into modern code candidates 245. The code generation subsystem 220 can generate a deterministic workload stub based on the parsing output, and subsequently orchestrate the LLM subsystem 222 by providing bite-sized modernization tasks to an LLM agent. The LLM subsystem 222 returns generated code snippets, which the code generation subsystem 220 can stitch together to create the modern code candidates 245. This process is described in more detail below with reference to FIG. 3.

The behavior verification subsystem 270 is configured to evaluate the functional correctness of the code candidates 245. The behavior verification subsystem 270 can execute the code candidates 245 using the captured data inputs from the backtest packets 255, and can compare the generated outputs against the expected legacy outputs stored within the respective backtest packets 255. If discrepancies are identified, the differences can be fed back into the code generation subsystem 220 and the LLM subsystem 222 to iteratively heal the code candidates 245. Alternatively or in addition, the differences can be provided to human engineers, who can continually use such information to refine the code candidates 245.

Once behavioral equivalence is proven by successfully matching the outputs of the backtest packets 255, the validated code candidates 245 can begin to be integrated with the rest of the target system 204.

In some implementations, the target system 204 is equipped with a runtime framework, which may be referred to as an orchestration subsystem, configured to execute the validated code candidates 245 in order to achieve integration equivalence. Integration equivalence means that the incrementally modernized workloads executing on the target system 204 can seamlessly communicate with unmigrated upstream and downstream consumers on the legacy production system 206. To achieve integration equivalence, the runtime framework can serve as a bridge representation between legacy execution scripts, such as Job Control Language (JCL) scripts, and the modernized batch programs.

The runtime framework is configured to integrate directly with the legacy enterprise scheduler of the legacy production system 206. This scheduler integration ensures that the modernized workloads are triggered at the correct time and that the individual job steps are executed in a correct and deterministic order. By maintaining this link to the legacy scheduler, the target system 204 can continuously operate in harmony with the legacy production system 206 without disrupting overarching business processes or requiring a complete system cutover.

Furthermore, the runtime framework encapsulates boilerplate mainframe capabilities and operational complexities, thereby abstracting them away from the modernized business logic. For example, the runtime framework can be configured to automatically manage dataset operations, such as copying, creating, deleting, or truncating data files.

The runtime framework can also provide built-in mechanisms for decoding input data from legacy encodings, such as Extended Binary Coded Decimal Interchange Code (EBCDIC), and encoding output data back into legacy formats for reintegration onto the mainframe.

Additionally, the runtime framework provides for job and step-level restartability. This allows jobs to gracefully resume execution following a failure by specifically managing the state of the job so that it can be gracefully resumed without re-executing steps that may alter its state.

FIG. 3 is a flowchart of an example process for generating and iteratively validating modern replica candidates. The example process can be performed by a system of one or more computers in one or more locations and programmed in accordance with this specification. For example, the process can be performed by the modernization system 202 described above with reference to FIG. 2.

The system analyzes legacy code (310). To properly scope and direct the modernization effort, the system can utilize deterministic parsing to extract dependencies, configurations, and data flows from the legacy codebase.

The system captures production data (320). Based on the data flows identified during the analysis step, the system can securely capture historical production data inputs and expected outputs, saving them as a collection of backtest packets.

The system generates replica candidates (330). The system can orchestrate an one or more LLMs to iteratively translate the legacy logic into a modern programming language implementation.

In some implementations, generating the replica candidates comprises a multi-step orchestration process that combines deterministic code scaffolding with non-deterministic artificial intelligence generation.

First, a code generation subsystem can utilize a deterministic scaffold generator to construct a workload stub. This workload stub can be built automatically based on the dependencies, configurations, and data flows extracted during the legacy code analysis phase. By structuring the application architecture upfront, the workload stub provides a deterministic framework that provides boundaries to the large language model. This effectively mitigates the hallucinogenic tendencies inherent with non-deterministic LLMs, which helps to ensure that the generated modern code performs the intended legacy behavior with minimal noise.

Additionally, as part of this scaffolding, the system can generate a bridge representation, such as a working storage emulator. The emulator can map the unique memory patterns and data semantics of the legacy language (e.g., COBOL) into the modern target language (e.g., Java).

Specifically, the generation of the bridge representation can be driven by the deterministic analysis performed by the parsing subsystem. During the analysis phase, the parsing subsystem can systematically evaluate the legacy source code, such as COBOL code, to explicitly identify and describe the structure of the legacy working storage. This process can include extracting detailed information characterizing how the legacy program allocates, stores, and interacts with memory during runtime execution.

Using this deterministically parsed information, the code generation subsystem can use custom modern technologies provided by the modern target language, e.g., Java, that replicate the unique memory patterns and data semantics of the legacy language.

Unlike traditional approaches to legacy software modernization, which typically rely on error-prone manual reverse engineering or the naive application of generative artificial intelligence that is highly prone to hallucination, the generation of this custom bridge representation provides significant technological advantages for the modernization computing system. By deterministically establishing a memory architecture in the target language that mimics the unique legacy data semantics (e.g., COBOL working storage), the system provides an unconventional solution to the problem of non-deterministic code translation. In particular, the deterministic bridge acts as a framework that bounds the generative operations of the LLM, thereby preventing the model from hallucinating or inventing its own complex, error-prone memory management workarounds. Consequently, this provides the modernization system with significant technological advantages by seamlessly combining this deterministic memory bridge with off-the-shelf, non-deterministic artificial intelligence tooling. This specific integration allows the computing system to much more accurately, efficiently, and reliably translate legacy code into a modern equivalent, thereby successfully overcoming the combinatorial complexities and high failure rates that have plagued conventional code translation systems.

To populate the workload stub with functional logic, the system can orchestrate an large language model by dividing the translation process into manageable, bite-sized modernization tasks. Rather than attempting to translate an entire monolithic legacy program at once, the system can construct a highly specific context package for each individual task.

The context can include: 1) the relevant portion of the legacy code, such as a single COBOL function or a built-in mainframe utility like SORT; 2) the associated configurations and variables; and 3) a suite of artificial intelligence “skills.”

These AI skills act as explicit instructions that inform an LLM about how to utilize the modernization system's proprietary tooling, e.g., how to securely read a file from the legacy data capture system or how to properly manipulate the working storage emulator in the target language. The LLM can then return generated code snippets, which the system can combine into the workload stub in order to form a complete replica candidate. A detailed example is described below.

In some implementations, the code generation step can further include orchestrating the LLM to conduct automated code reviews of its own output, or prompting the model to refactor the generated modern code to improve its structure and performance before it proceeds to the characterization testing phase.

The system analyzes the replica candidates (340). To rapidly assess the correctness of the newly generated code, the system can execute a suite of characterization tests against the replica candidates. The characterization tests are unit tests that describe the behavior of the legacy program in small pieces, often utilizing synthetic input data. By way of example, the system can provide LLM agents with specialized tools to write a test suite specific to a single legacy program, such as a COBOL program. The test suite can comprise multiple individual tests that explicitly define what the legacy program does when presented with a particular piece of input data. To generate these tests, the system can apply lightweight transformations to compile the legacy COBOL code for a local environment, e.g., Linux, execute the code using generated synthetic input data, and capture the observed behavior as a set of correct and meaningful runnable tests. Once verified against the local legacy code, the same test suite can subsequently be reused to validate the behavior of the modern replica candidates.

To generate these characterization tests, the modernization system can orchestrate one or more LLM agents with context packages and a suite of executable tools, which may referred to as skills. In this specification, a skill is a predefined software tool, function, or application programming interface (API) along with its associated instructions that allows an LLM agent to properly interact with the deterministic tooling of the modernization system. For example, a skill can include an executable tool that allows the LLM agent to securely read a specific legacy file format, a tool that formats synthetic data payloads to match legacy memory constraints, or a tool that enables the agent to interact with a legacy screen interface and make programmatic assertions about the visual state of the screen, to name just a few examples.

Then system can then execute the legacy program and prompt the LLM agent to use skills to write test code. For example, the system can apply lightweight modifications to a specific legacy program, e.g., a COBOL program, so that it can be compiled and executed in a local environment. The system can then prompts the LLM agent to analyze this legacy code and utilize its provided skills to generate synthetic input data. The agent can provide this synthetic data to the local legacy program and capture the observed behavior. Based on these observations, the LLM agent can uses the skills to write characterization tests that explicitly define the expected behavior of the program in discrete pieces, e.g., asserting exactly what output is expected for a given synthetic input.

Through this iterative, AI-driven process, the system can automatically build up a comprehensive, accurate test suite tailored to a single legacy program, which subsequently serves as a verification baseline for the modern replica candidates.

As one example, the suite of characterization tests can include a data routing verification test configured to validate how a modern replica candidate reads, splits, and distributes input data. In such a test, the system can generate synthetic input records of a plurality of different discrete data types, such as customer records, account records, transaction records, and intentionally unknown or invalid records. The characterization test can execute the replica candidate using the synthetic input records and assert that the replica candidate handles empty files gracefully without crashing, correctly identifies the different data types, and accurately routes each specific data type into a corresponding distinct output file, thereby perfectly matching the data splitting behavior of the legacy program. If these are not handled correctly by the modern replica candidate, the system can use that information to modify or regenerate the modern replicate candidate.

As another example, the suite of characterization tests can include a business logic categorization test configured to validate how the modern replica candidate applies complex legacy rules to evaluate and sort data. In this scenario, the system can generate a batch of synthetic input records that include intentionally invalid data, various error codes, numeric variances, and specific resolution statuses. The characterization test can execute the replica candidate and make assertions to verify that the replica candidate strictly enforces legacy input validation rules that skip the invalid data. Furthermore, the test can verify that the replica candidate accurately applies specific threshold-based variance rules, delay rules, and global overrides to correctly categorize remaining valid records into appropriate severity levels (e.g., critical, warning, or info), while also accurately generating the expected summary outputs.

In some implementations, the suite of characterization tests can also be generated and executed for legacy user interactions, such as transactional mainframe environments or green screen applications, e.g., Customer Information Control System (CICS) screens. For these transactional workloads, the system can provide LLM agents with specific skills detailing how to interact with the legacy screens, either through traditional legacy terminal interfaces or via modern web browsers. The LLM agents can be directed to write tests that navigate the legacy screen flow using synthetic input data and can make a plurality of assertions regarding the expected visual state and the specific data displayed on the screen.

Similar to the batch program characterization, these screen-based tests can be first executed against the legacy screen interface to verify their correctness and capture the baseline visual behavior. Once verified, the same test suite can be subsequently utilized to validate the behavior of the modern replica candidates, ensuring the modernized user interface and underlying transactional logic faithfully reproduce the legacy screen interactions.

The system determines whether the replica candidates pass the unit tests (350).

If the replica candidates produce errors or fail to pass the unit tests, the system adds the discrepancy to the context (branch to 380) and returns to step 330 to generate updated replica candidates.

In some implementations, adding the discrepancy to the context comprises capturing execution failures and packaging them as fast feedback to automatically guide the LLM agents. For example, during the inner characterization testing loop, if the modern replica candidate fails to compile, the system can capture specific error messages generated by the compiler. Alternatively or in addition, if the replica candidate successfully compiles but fails to pass the synthetic unit tests, the system can compute the exact mathematical or formatting discrepancy between the output generated by the modern code and the expected legacy output defined by the test.

The system can then construct an updated context package. This updated context can include the captured error messages or computed discrepancies, the relevant portions of the legacy source code, the current iteration of the modern candidate code, and the test suite itself.

This updated context package can then be provided back to the LLM agent as explicit feedback, which can be generated and incorporated relatively rapidly. The system can then prompt the LLM agent to analyze the discrepancy, to identify the incorrect logic or formatting differences, and to generate a corrected version of the code

By programmatically feeding the exact failure conditions back into the LLM, the system can perform an automated job-step iteration loop where the modern code is continuously refined and healed until it successfully passes the entire suite of characterization tests.

This sequence of executing steps 330, 340, 350, and 380 may be referred to as an “inner loop” of code generation. The inner loop provides fast feedback to the LLM, allowing it to continuously refine the modern implementation until it successfully replicates the baseline logic of the legacy program.

If the replica candidates successfully pass the unit tests, the system analyzes behavioral equivalence (branch to 360). Having passed the initial synthetic unit tests, the system can execute the modern replica candidates using the actual production data inputs captured in the backtest packets.

The system determines whether behavioral equivalence is achieved (370). To do so, the system can compare the outputs generated by the replica candidates against the expected legacy outputs stored in the previously generated backtest packets.

If behavioral equivalence is not achieved, the system can compute the differences and adds these discrepancies to the code generation context (branch to 380), and the system can then return to step 330 to iteratively heal the replica candidates using this new, real-world data context.

In some implementations, if behavioral equivalence is not achieved, it indicates that the modern replica candidates failed the validation step for one of several reasons, such as compilation errors, incorrect interpretation of inputs, flawed implementation of business logic, or incorrect output formatting.

To resolve these failures, the system can initiate an automated healing process to refine the generated code. For example, in the event of a failure to generate equivalent output, the system can compute the discrepancies between the output generated by the modern replica candidates and the expected legacy output stored within the respective backtest packet. These captured discrepancies constitute context indicating how the first iteration of the modern code is incorrect. Thereafter, the system can construct an updated context package that includes these computed differences, along with relevant portions of the final product, the legacy source code, and the backtest packets.

The system can then provide this context package back to the LLM agent and can direct the model to generate code that corrects the error. The LLM agent can then analyze the discrepancy to generate a second iteration of the modern code, which is subsequently passed back through the validation step.

By way of example, the modern code may generate output that fails to match the backtest packet due to a minor formatting difference, such as missing spaces between data fields. The system can compute this formatting discrepancy, add it to the code generation context, and prompt the LLM agent to take note of the formatting differences and to update the modern code in a way that will correctly format the output.

This process can be repeated until all discrepancies are resolved and all available backtest packets succeed, indicating that the modern code replicates the behavior of the legacy code under the same inputs.

This sequence through steps 360, 370, and 380 constitutes a data-driven “outer loop” that ensures the modern code correctly handles real-world edge cases and unpredictable production scenarios that the synthetic inner loop may not have accounted for.

If behavioral equivalence is achieved across all available backtest packets, the iterative healing loops conclude, and the process ends (branch to end). The end result is a fully verified, behaviorally equivalent modern application that can begin integration into production with the legacy system.

The modernization system can also be configured to continuously learn and improve its code generation capabilities over time by incorporating human intervention feedback. While the iterative inner and outer loops described above automatically resolve many execution discrepancies, certain complex edge cases may require a human modernization engineer to manually intervene and correct the generated modern code.

When such manual intervention occurs, the system can capture the engineer's specific corrections and utilize this feedback to automatically modify baseline prompts and generated skills, thereby effectively teaching the system's tooling how to correctly handle similar scenarios in the future.

By persistently capturing human interventions and updating the underlying code generation context, the system can permanently learn from manual corrections, thereby continuously increasing the accuracy and efficiency of subsequent modernization tasks.

A more detailed example of a code modernization process will now be described through the lens of a typical, example, legacy mainframe batch job, which will be referred to as BATCH 101. Typical batch jobs, like BATCH 101, run on legacy mainframe hardware and operating systems (e.g. IBM Z/OS, HPE Nonstop). Batch jobs are scheduled to run either periodically, at specific times, or in response to user input. The scheduling is performed by a workload scheduler (e.g. IBM Z Workload Scheduler, ESP dSeries) running on the mainframe.

When BATCH101 is to be run, the scheduler invokes the BATCH101 entry point. This is typically a set of instructions written in a particular legacy language (e.g. JCL). These instructions perform several tasks including but not limited to:
Preparing and connecting to sources of input data.
Copying, moving, and deleting input data.
Merging, sorting, or concatenating input data.
Setting up mainframe resources for subsequent use by programs associated with the batch job.
Configuring and invoking programs to perform job-specific tasks. Potentially providing these programs with input parameters, references to tape and file-based data storage, references to database (e.g. Oracle, DB2), and/or references to message bus queues (e.g. IBM MQ).
Collecting the output data of these jobs.
Merging, sorting, or concatenating output data.
Copying, moving, and deleting output data.
Uploading, transmitting, or printing output data.
Logging to indicate the beginning, progress, and end of the batch job.

All of these tasks are typically performed by a combination of mainframe-provided tools (e.g. IDCAMS, SORT, IEBGENER, IKJEFT01, CSSMTP etc.), third-party tools installed on the mainframe (e.g. PKZIP for compression, TIBCO OSIUC000 for file upload and download), and custom software written by the legacy software developers to perform business functions (e.g. source code written in COBOL or database manipulations written in various SQL dialects).

Note that a BATCH101 might invoke several different programs, to perform several different operations, and manipulate several different kinds of data (e.g. files, database tables, message queues). These programs and the batch script itself (e.g. the JCL commands) may be referred to as Dependencies, to their configurations as Configurations, and to their data inputs, and data outputs as Data Flows.

At the highest level BATCH101 is operating on a set of inputs (data and configuration) and, ultimately, generating a set of outputs. To faithfully replicate the behavior of BATCH101 a modernized replacement must be capable of accepting the same data inputs and configurations and generating equivalent outputs.

For concreteness, an example BATCH101 is presented in pseudocode. This BATCH101 is for a multinational company that must generate Tax Protected Status reports for each nation it operates in to ensure its daily sales activities are in compliance with local regulations:

TABLE 1
Unset

STEP-1: MAKE TEMPORARY-FILE TAX-PROTECTED-STATUS
STEP-2: COPY US-DAILY-SALES TO TAX-PROTECTED-STATUS
STEP-3: COPY CAN-DAILY-SALES TO TAX-PROTECTED-STATUS
STEP-4: COPY EU-DAILY-SALES TO TAX-PROTECTED-STATUS
STEP-5: SORT TAX-PROTECTED-STATUS BY PRICE AND REMOVE ITEMS
WITH PRICE < $10
STEP-6: INVOKE TAX-PROTECTED-STATUS-REPORTER WITH INPUT-
FILE.TAX-PROTECTED-STATUS AND OUTPUT-FILE.TAX-PROTECTED-
STATUS-REPORT
STEP-7: SEND TAX-PROTECTED-STATUS-REPORT TO
COMPTROLLER@EXAMPLE.COM
STEP-8: BACKUP TAX-PROTECTED-STATUS-REPORT TO TAX-PROTECT-
STATUS-STORAGE
STEP-9: DELETE TEMPORARY-FILE TAX-PROTECTED-STATUS

Note that TAX-PROTECTED-STATUS-REPORTER is itself a custom program (e.g. written in COBOL) that reads from an input file, writes to an output file, and reads from a DB2 SQL table called TAX-REGULATIONS to ensure it has the latest tax regulations to generate the output file report. The annotations in TABLE 1 are as follows: Dependencies are underlined, Data Flows are bolded, Configurations are in italics.

To successfully modernize BATCH 101, the system can perform the following steps must:
1. Identify all Dependencies, Configurations, and Data Flows for the BATCH 101 entry point.
2. Instrument the legacy system and schedule workloads to exfiltrate these Data Flows and store Backtest Packets.
3. Parse the source Dependencies to produce a workload stub.
4. Orchestrate an LLM agent to populate the workload stub with Modern Code, providing the Dependencies and Configurations as guiding inputs.
5. Verify replication by Backtesting the Modern Code against stored Backtest Packets.
6. Repeat steps 4-5, providing verification results to the LLM agent to heal the Modern Code until the replication is fully validated and correct.

Each step will now be described in further detail. The system can include a User Interface to visualize the legacy Dependencies and Data Flows, available Backtest Packets, and progress towards validated Modern Code.

### Step 1—Identify

In order to determine the Dependencies and Configurations of the BATCH101 entrypoint, and to identify which Data Flows to exfiltrate the system first parses the BATCH101 entrypoint file.

The Parser is a fast, deterministic, parser that supports the common legacy languages (e.g. JCL, COBOL, etc.), built-in tools (e.g. SORT, IDCAMS, etc.), and third-party tools (e.g. PKZIP, TIBCO OSIUC000). The Parser identifies Dependencies (i.e. which programs are called by each BATCH101 step), Configurations (i.e. what parameters are passed to them) and Data Flows (i.e. whatinputs and outputs are associated with each BATCH101 step).

The Parser can produce JSON-formatted output that captures these three aspects and their relationships. It can run against a particular entrypoint to identify its Dependencies, Configurations, and Data Flows for further processing. It can also run against an entire legacy codebase to identify the set of entrypoints and their many Dependencies and Data Flows. This latter capability can be used to (a) visualize the broader legacy architecture (see FIG. 2) and (b) prioritize which legacy workloads to modernize first on the basis of their complexity and interconnectedness.

Step 2—Instrument, Schedule. Exfiltrate. And Store Backtest Packets

Once the relevant Data Flows have been identified they need to be fetched from the legacy system. Specifically, the system can identify the correct moment to fetch inputs (i.e. before the job in question begins) and to fetch outputs (i.e. after the job in question ends) in order to generate a correct set of inputs and outputs that captures the job's behavior.

Because jobs typically run periodically there are many such input-output pairs. Each unique pair is referred to as a data Backtest Packet. The Backtest Packet Manager (IBPM) identifies the correct time to perform these fetch operations, and provides an MO-proprietary suite of data connectors to observe, capture, and download these data Backtest Packets into cloud storage. The IBPM catalogs and timestamps these Backtest Packets and provides the rest of the platform with programmatic access to the packets.

In our BATCH101 example, the IBPM would interpret the mainframe scheduler inputs to identify the inputs to BATCH101 (the US-DAILY-SALES, CAN-DAILY-SALES, EU-DAILY-SALES files, and the TAX-REGULATIONS table) and the outputs (the TAX-PROTECTED-STATUS-REPORT and the email sent). It would then use the appropriate data connector (e.g. a file reader, or a database table copier, or an e-mail extractor) to copy the entire contents of the input files prior to invocation of the job and the output files after the job has been completed. These assets are then cataloged and stored in cloud storage as a Backtest Packet. The process is repeated periodically every time BATCH 101 runs in order to build a suite of Backtest Packets for the entrypoint. IBPM does this at scale for each individual workload being modernized.

The IBPM can be queried to identify the number of Backtest Packets for a given entrypoint and to fetch any given Backtest Packet.

### Step 3—Generate a Workload Stub

In order to successfully leverage non-deterministic Al LLMs to modernize legacy code, the platform can structure non-deterministic LLM outputs within a rigid deterministic framework and validate them against deterministic Backtest Packets.

As has been widely documented, LLMs are prone to hallucination. In order to rein in these hallucinogenic tendencies and produce clear and clean modern code that performs no more and no less than the intended legacy system behavior, the system provides boundaries and structure to the LLM. To accomplish this, the deterministic parsed output of the Parser (described in step 1, above) is used to construct a workload stub that mirrors the operations performed by the legacy system with minimal noise.

Moreover the workload stub is structured to represent a more modern approach and architecture to solve the underlying problem. It leverages a runtime library to provide functionality that provides modern access patterns for the legacy software context.

### Step 4—Orchestrate an LLM Agent

LLMs can perform actions by being provided with context and directed to accomplish a task. In order to mitigate hallucination and/or outright failure the LLM must be orchestrated through a series of smaller tasks in order to successfully reconstruct a modern version of a large legacy codebase.

The system is capable of such orchestration. Through a combination of structured output from the Parser, language-specific libraries built and maintained, and hand-tuned prompts the system can present the LLM agent with bite-sized modernization tasks. It does this by constructing a context that includes only the task to be accomplished, along with constraints on how to accomplish the task.

For example, if the task entails translating a COBOL function that reads a file and stores its output in a COBOL variable, the LLM agent is provided with the source code of just that COBOL function (i.e. the Dependency), the name of the file (i.e. the configuration), and information about tooling for (a) reading files from the legacy system and (b) structuring and manipulating data structures in the target language that mimic the behavior of COBOL variables. The LLM agent is also provided with the relevant portions of the workload stub and/or the final product to provide context about the functions that may call or be called by the function in question.

If the task entails translating a SORT mainframe built-in program the LLM agent is provided with the input and output file names and the configurations provided to the SORT program along with information about the system's tooling for reading files and the structure of the files.

If the task entails double-checking the output of a prior task, an LLM agent is asked to perform a code review.

If tasks have resulted in generated output, an LLM agent may be asked to refactor the generated code to improve its structure and/or performance.

Each such task results in an LLM prompt managed by the system orchestrator.

### Step 5—Validate

Once the first iteration of the Modern Code is completed, the system attempts to compile and run the Modern Code against a sample Backtest Packet.

This entails:
1. Compiling the Modern Code to generate a modernized executable
2. Providing the executable with the inputs captured in the Backtest Packet
3. Running the executable and collecting the outputs generated by it
4. Comparing the outputs of the executable with the outputs captured in the Backtest Packet.

This final comparison requires that the outputs generated by the Modern Code match the outputs captured in the Backtest Packet. If a match is identified the Backtest Packet is said to have succeeded. Otherwise the Backtest Packet is said to have failed. In the case of a failed Backtest Packet the system can compute the discrepancy between the outputs of the Modern Code and the outputs of the legacy system captured in the Backtest Packet.

The Modern Code is said to be equivalent if it succeeds for all available Backtest Packets.

### Step 6—Heal and Refine

Often, the first iteration of the Modern Code will not be equivalent. It may fail the Validation Step (step 5) for various reasons:
1. There may be Compilation Errors due to errors or inconsistencies in the LLM generated Modern Code.
2. The Modern Code may fail to generate equivalent output because it incorrectly implements the legacy behavior. For example:
a. The Modern Code may incorrectly interpret its inputs.
b. The Modern Code may provide an incorrect implementation of some aspect of the legacy system's business logic.
c. The Modern Code may fail to format its output correctly.

In the case of Compilation Errors, the system will capture the error messages generated by the compiler.

In the case of a failure to generate equivalent output, the system will compute and store the discrepancy between the Modern Code's output and the legacy system's output stored in the Backtest Packet.

In both cases these captured assets constitute context about how the first iteration of the Modern Code is incorrect. Mirroring step 4 with this context, along with relevant portions of the final product and the legacy code and Backtest Packets are provided to an LLM agent, which is directed to correct the error. This results in a second iteration which can be passed through step 5 for validation.

After the Backtest Packets are validated, the Modern Code is considered to be behaviorally equivalent. It faithfully reproduces the behavior of the legacy code as validated by the Backtest Packets. In the case of BATCH101 the Modern Code could be an Elixir, Python, or Java program (etc.) that can:
1. Read the US-DAILY-SALES, CAN-DAILY-SALES, EU-DAILY-SALES file inputs, applying the appropriate price filters.
2. Read the TAX-REGULATIONS table as needed.
3. Perform the business logic necessary to process these inputs and produce the TAX-PROTECTED-STATUS-REPORT in an identical format as the legacy system
4. Store a backup copy of the report.
5. And send an e-mail of the report.

This Modern Code would likely avoid the unnecessary step of producing the temporary TAX-PROTECTED-STATUS file and would leverage the modernization tools and frameworks to integrate with the legacy system and read and manipulate its inputs.

Once complete, the Modern Code can be deployed to the client's modern infrastructure and run alongside the legacy system. Multiple transition strategies are available at this point ranging from a complete cutover to running in parallel with the legacy system and performing continued Backtest Packet validation to further increase confidence in the Modern Code.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
parsing a legacy code base to identify one or more data flows between modules executing on a legacy production system;
capturing, based on the identified one or more data flows, production data inputs and expected legacy outputs generated by the legacy production system executing the legacy code base to generate one or more backtest packets;
generating, by a large language model (LLM) agent using a current system context, a modern code candidate for a legacy module executing on the legacy production system;
executing the modern code candidate using the production data inputs from one or more backtest packets to generate modern outputs for the modern code candidate;
comparing the generated modern outputs to one or more expected legacy outputs from one or more backtest packets to determine whether the modern code candidate has behavioral equivalence with the legacy module;
in response to determining that behavioral equivalence has not been achieved, computing one or more discrepancies between the generated modern outputs and the expected legacy outputs; and
generating an updated system context including adding the computed discrepancies to the system context for the LLM agent; and
iteratively generating, by the LLM agent using the updated system context, an updated modern code candidate.

Embodiment 2 is the method of embodiment 1, wherein generating the modern code candidate for the legacy module comprises:
generating a suite of characterization tests for the legacy module, wherein the characterization tests comprise unit tests utilizing synthetic input data;
executing the suite of characterization tests against an initial iteration of the modern code candidate;
determining whether the initial iteration of the modern code candidate passes the suite of characterization tests; and
in response to determining that the initial iteration of the modern code candidate fails to pass one or more tests of the suite of characterization tests, capturing one or more execution failures and adding the captured execution failures to the current system context.

Embodiment 3 is the method of embodiment 2, further comprising iteratively refining, by the LLM agent, the initial iteration of the modern code candidate until the suite of characterization tests is passed.

Embodiment 4 is the method of embodiment 2, wherein the legacy module comprises a transactional user interface, and wherein generating the suite of characterization tests comprises:
generating one or more tests configured to navigate a legacy screen flow using the synthetic input data; and
making one or more assertions regarding an expected visual state and specific data displayed on the transactional user interface.

Embodiment 5 is the method of embodiment 2, wherein generating the suite of characterization tests for the legacy module comprises:
providing the LLM agent with one or more skills, wherein the one or more skills comprise executable tools that allow the LLM agent to interact with deterministic tooling of a modernization computing system;
prompting the LLM agent to execute the local version of the legacy module using the synthetic input data via the one or more skills and to automatically generate one or more of the unit tests based on observed behavior of the local version of the legacy module processing the synthetic input data.

Embodiment 6 is the method of any one of embodiments 1-5, further comprising iteratively refining, by the LLM agent, the initial iteration of the modern code candidate until behavioral equivalence has been achieved.

Embodiment 7 is the method of any one of embodiments 1-6, wherein parsing the legacy code base comprises extracting a memory allocation structure of the legacy code base, and further comprising:
generating a bridge representation in a modern target language based on the extracted memory allocation structure, wherein the bridge representation replicates legacy data semantics of the legacy code base; and
generating, by the LLM agent, a workload stub that uses the deterministic bridge representation to bound generative operations of the LLM agent.

Embodiment 8 is the method of any one of embodiments 1-7, further comprising:
receiving one or more manual corrections to the updated modern code candidate from a user; and
updating one or more baseline prompts or skills for the LLM agent based on the received manual corrections.

Embodiment 9 is the method of embodiment 8, wherein the updating persistently improves subsequent code generation tasks by the LLM agent.

Embodiment 10 is the method of any one of embodiments 1-9, further comprising:
deploying the updated modern code candidate to a target system comprising a runtime framework configured to achieve integration equivalence, wherein the runtime framework integrates with a legacy enterprise scheduler of the legacy production system to trigger execution of the updated modern code candidate.

Embodiment 11 is the method of embodiment 10, and wherein the runtime framework is configured to provide step-level restartability for the updated modern code candidate by managing a state of a task performed by the updated modern code candidate.

Embodiment 12 is the method of any one of claims 1-11, further comprising:
automatically initiating, via a web-based user interface, iterative code generation and validation loops for a plurality of legacy programs simultaneously;
automatically executing modern code candidates for the plurality of legacy programs against a plurality of corresponding backtest packets in parallel; and
aggregating verification results and test coverage metrics for presentation in the web-based user interface.

Embodiment 13 is the method of any one of embodiments 1-12, wherein capturing the production data inputs and the expected legacy outputs comprises: utilizing change data capture (CDC) streams, point-in-time snapshotting, or both, to record a state of one or more legacy database tables without halting production operations of the legacy production system.

Embodiment 14 is the method of any one of embodiments 1-13, wherein generating the backtest packets is a deterministic process that causes code generated by a non-deterministic LLM to deterministically replicate behavior of the legacy code module after behavioral equivalence is attained.

Embodiment 15 is a system comprising: one or more computers and one or more storage devices storing instructions that are operable, when executed by the one or more computers, to cause the one or more computers to perform the method of any one of embodiments 1 to 14.

Embodiment 16 is a computer storage medium encoded with a computer program, the program comprising instructions that are operable, when executed by data processing apparatus, to cause the data processing apparatus to perform the method of any one of embodiments 1 to 14.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer-implemented method comprising:
parsing a legacy code base to identify one or more data flows between modules executing on a legacy production system;
capturing, based on the identified one or more data flows, production data inputs and expected legacy outputs generated by the legacy production system executing the legacy code base to generate one or more backtest packets;
generating, by a large language model (LLM) agent using a current system context, a modern code candidate for a legacy module executing on the legacy production system;
executing the modern code candidate using the production data inputs from one or more backtest packets to generate modern outputs for the modern code candidate;
comparing the generated modern outputs to one or more expected legacy outputs from one or more backtest packets to determine whether the modern code candidate has behavioral equivalence with the legacy module;
in response to determining that behavioral equivalence has not been achieved, computing one or more discrepancies between the generated modern outputs and the expected legacy outputs; and
generating an updated system context including adding the computed discrepancies to the system context for the LLM agent; and
iteratively generating, by the LLM agent using the updated system context, an updated modern code candidate.

2. The method of claim 1, wherein generating the modern code candidate for the legacy module comprises:
generating a suite of characterization tests for the legacy module, wherein the characterization tests comprise unit tests utilizing synthetic input data;
executing the suite of characterization tests against an initial iteration of the modern code candidate;
determining whether the initial iteration of the modern code candidate passes the suite of characterization tests; and
in response to determining that the initial iteration of the modern code candidate fails to pass one or more tests of the suite of characterization tests, capturing one or more execution failures and adding the captured execution failures to the current system context.

3. The method of claim 2, further comprising iteratively refining, by the LLM agent, the initial iteration of the modern code candidate until the suite of characterization tests is passed.

4. The method of claim 2, wherein the legacy module comprises a transactional user interface, and wherein generating the suite of characterization tests comprises:
generating one or more tests configured to navigate a legacy screen flow using the synthetic input data; and
making one or more assertions regarding an expected visual state and specific data displayed on the transactional user interface.

5. The method of claim 2, wherein generating the suite of characterization tests for the legacy module comprises:
providing the LLM agent with one or more skills, wherein the one or more skills comprise executable tools that allow the LLM agent to interact with deterministic tooling of a modernization computing system;
prompting the LLM agent to execute the local version of the legacy module using the synthetic input data via the one or more skills and to automatically generate one or more of the unit tests based on observed behavior of the local version of the legacy module processing the synthetic input data.

6. The method of claim 1, further comprising iteratively refining, by the LLM agent, the initial iteration of the modern code candidate until behavioral equivalence has been achieved.

7. The method of claim 1, wherein parsing the legacy code base comprises extracting a memory allocation structure of the legacy code base, and further comprising:
generating a bridge representation in a modern target language based on the extracted memory allocation structure, wherein the bridge representation replicates legacy data semantics of the legacy code base; and
generating, by the LLM agent, a workload stub that uses the deterministic bridge representation to bound generative operations of the LLM agent.

8. The method of claim 1, further comprising:
receiving one or more manual corrections to the updated modern code candidate from a user; and
updating one or more baseline prompts or skills for the LLM agent based on the received manual corrections.

9. The method of claim 8, wherein the updating persistently improves subsequent code generation tasks by the LLM agent.

10. The method of claim 1, further comprising:
deploying the updated modern code candidate to a target system comprising a runtime framework configured to achieve integration equivalence, wherein the runtime framework integrates with a legacy enterprise scheduler of the legacy production system to trigger execution of the updated modern code candidate.

11. The method of claim 10, and wherein the runtime framework is configured to provide step-level restartability for the updated modern code candidate by managing a state of a task performed by the updated modern code candidate.

12. The method of claim 1, further comprising:
automatically initiating, via a web-based user interface, iterative code generation and validation loops for a plurality of legacy programs simultaneously;
automatically executing modern code candidates for the plurality of legacy programs against a plurality of corresponding backtest packets in parallel; and
aggregating verification results and test coverage metrics for presentation in the web-based user interface.

13. The method of claim 1, wherein capturing the production data inputs and the expected legacy outputs comprises: utilizing change data capture (CDC) streams, point-in-time snapshotting, or both, to record a state of one or more legacy database tables without halting production operations of the legacy production system.

14. The method of claim 1, wherein generating the backtest packets is a deterministic process that causes code generated by a non-deterministic LLM to deterministically replicate behavior of the legacy code module after behavioral equivalence is attained.

15. A system comprising:
one or more computers and one or more storage devices storing instructions that are operable, when executed by the one or more computers, to cause the one or more computers to perform operations comprising:
parsing a legacy code base to identify one or more data flows between modules executing on a legacy production system;
capturing, based on the identified one or more data flows, production data inputs and expected legacy outputs generated by the legacy production system executing the legacy code base to generate one or more backtest packets;
generating, by a large language model (LLM) agent using a current system context, a modern code candidate for a legacy module executing on the legacy production system;
executing the modern code candidate using the production data inputs from one or more backtest packets to generate modern outputs for the modern code candidate;
comparing the generated modern outputs to one or more expected legacy outputs from one or more backtest packets to determine whether the modern code candidate has behavioral equivalence with the legacy module;
in response to determining that behavioral equivalence has not been achieved, computing one or more discrepancies between the generated modern outputs and the expected legacy outputs; and
generating an updated system context including adding the computed discrepancies to the system context for the LLM agent; and
iteratively generating, by the LLM agent using the updated system context, an updated modern code candidate.

16. The system of claim 15, wherein generating the modern code candidate for the legacy module comprises:
generating a suite of characterization tests for the legacy module, wherein the characterization tests comprise unit tests utilizing synthetic input data;
executing the suite of characterization tests against an initial iteration of the modern code candidate;
determining whether the initial iteration of the modern code candidate passes the suite of characterization tests; and
in response to determining that the initial iteration of the modern code candidate fails to pass one or more tests of the suite of characterization tests, capturing one or more execution failures and adding the captured execution failures to the current system context.

17. The system of claim 16, wherein the operations further comprise iteratively refining, by the LLM agent, the initial iteration of the modern code candidate until the suite of characterization tests is passed.

18. The system of claim 16, wherein the legacy module comprises a transactional user interface, and wherein generating the suite of characterization tests comprises:
generating one or more tests configured to navigate a legacy screen flow using the synthetic input data; and
making one or more assertions regarding an expected visual state and specific data displayed on the transactional user interface.

19. The system of claim 16, wherein generating the suite of characterization tests for the legacy module comprises:
providing the LLM agent with one or more skills, wherein the one or more skills comprise executable tools that allow the LLM agent to interact with deterministic tooling of a modernization computing system;
prompting the LLM agent to execute the local version of the legacy module using the synthetic input data via the one or more skills and to automatically generate one or more of the unit tests based on observed behavior of the local version of the legacy module processing the synthetic input data.

20. One or more non-transitory computer storage media encoded with computer program instructions that when executed by one or more computers cause the one or more computers to perform operations comprising:
parsing a legacy code base to identify one or more data flows between modules executing on a legacy production system;
capturing, based on the identified one or more data flows, production data inputs and expected legacy outputs generated by the legacy production system executing the legacy code base to generate one or more backtest packets;
generating, by a large language model (LLM) agent using a current system context, a modern code candidate for a legacy module executing on the legacy production system;
executing the modern code candidate using the production data inputs from one or more backtest packets to generate modern outputs for the modern code candidate;
comparing the generated modern outputs to one or more expected legacy outputs from one or more backtest packets to determine whether the modern code candidate has behavioral equivalence with the legacy module;
in response to determining that behavioral equivalence has not been achieved, computing one or more discrepancies between the generated modern outputs and the expected legacy outputs; and
generating an updated system context including adding the computed discrepancies to the system context for the LLM agent; and
iteratively generating, by the LLM agent using the updated system context, an updated modern code candidate.
